(19) United States
(12) Patent Application Publication
(10) Pub. No.: US 2005/0013200 A1
(43) Pub. Date: Jan. 20, 2005

(54) Method for displaying time in mobile terminal

(76) Inventor: Suk-Soo Choi, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/891,279

(22) Filed: Jul. 14, 2004

(30) Foreign Application Priority Data
Jul. 15, 2003 (KR) 2003-48249
Jun. 23, 2004 (KR) 2004-47310

(51) Int. Cl. G04B 19/22

(52) U.S. Cl. 368/21

(57) ABSTRACT

A method for providing precision current times of cities by using information stored in a time table for a mobile terminal is disclosed. In one embodiment, the method includes a) storing information about time differences between predetermined cities and a Greenwich Mean Time (GMT) in the storing unit of the mobile terminal, b) receiving time information from a base station when the mobile terminal is initialized, c) receiving a request of displaying a current time of a target city from a user, d) computing the current time of the target city based on the time information from the base station and the time table stored in the storing unit and e) displaying the computed current time of the target city on the displaying unit.

### FIELD OF THE INVENTION

The present invention relates to a method for displaying a time in a mobile terminal; and, more particularly, to a method for displaying precision current times of cities by using a time table stored in a mobile terminal and time information transmitted from a base station.

### DESCRIPTION OF RELATED ARTS

Each of cities around the world has a standard time based on a solar time. The standard times of cities are different since the solar time is varied according to a diurnal motion of a solar. That is, each of cities has different standard time varied according to a longitude of city.

The Greenwich Mean Time (GMT) is the former name of a mean solar time at the original site of the Royal Observatory in Greenwich, England, which is located on the prime meridian. The GMT is used as the international time standard common to every places in the world. The GMT nominally reflects the mean solar time along the earth's prime meridian.

The standard times of cities are calculated based on a time difference with the GMT. A city may have one hour faster standard time than the GMT, if the city is located at a region which is longitude 15° east away from Greenwich and toward to the East. In contrary, a city may have one hour slower standard time than the GMT, if the city is located at a region which is longitude 15° west away from Greenwich.

As mentioned above, the time difference between a city and Greenwich is determined based on the longitude of the city and the longitude of Greenwich and the standard time of city is calculated by using the time difference.

FIG. 1 shows a time table stored in a conventional mobile terminal for calculating a current time of a target city.

The conventional mobile terminal stores the time table including information about time differences of predetermined cities based on an origin city where the conventional mobile terminal is sold. In the time table in FIG. 1 includes information about time differences of predetermined cities based on a city of Seoul as the origin city.

When a user requests to display a current time of a target city, the conventional mobile terminal calculates the current time of the target city by using information about a time difference stored in the time table.

As shown, the time table includes a city field 110 storing names of predetermined cities and a time difference field 120 storing time difference values of corresponding cities. The time difference values are positive or negative integer number representing time difference between the origin city and predetermined cities. If a city has a positive integer number of a time difference value, a current time of the city is faster than the origin city and if a city has a negative integer number as the time difference value, a current time of the city is slower than the origin city.

For example, when a current time of Seoul is PM 12 o'clock on July 1^{st}, a current time of Sydney is calculated by adding a time difference value 1 to the current time of Seoul. That is, the current time of Sydney is PM 1 o'clock on July 1^{st}.

For another example, when a current time of Seoul is PM 12 O'clock on July 1^{st}, a current time of New York is calculated by adding a time difference value −14 from the current time of the Seoul. That is the current time of New York is PM 10 o'clock on June 30^{th}.

The conventional mobile terminal calculates a current time of target city according to the method as mentioned above and display the calculated current time on a displaying unit.

Recently, a world wide roaming service has been provided and widely used. With the world wide roaming service, a mobile terminal needs to accurately calculate current time of cities around the world.

However, the conventional mobile terminal having the time table in FIG. 1 cannot calculate a precision current time of a target city.

The time table in FIG. 1 does not include information of a summer time system. Therefore, the conventional mobile terminal may display wrong current time of a target city when a user wants a current time of the target city adopting the summer time system.

Furthermore, the time difference values in time table are computed based on a fundamental unit of one hour, which is 15° longitude difference. Therefore, the conventional mobile terminal may display wrong current time of a target city using a standard time which is multiple of 30 minutes different from the GMT. If the target city is multiple of 7.5° longitude away from Greenwich, the target city uses the standard time having multiple of 30 minutes difference from the GMT. For example, when GMT is PM 4 o'clock on July 1^{st}, a current time of New Delhi is PM 9:30 on July 1^{st}. Also, when GMT is PM 4 o'clock on July 1^{st}, a current time of Kabul is PM 8:30 on July 1^{st}.

Moreover, the time table of the conventional mobile terminal includes time difference values based on the origin city. The time table is stored at the conventional mobile terminal when the conventional mobile terminal is manufactured. Therefore, the time difference values must be modified when the origin city is changed. In other words, when the user travels to other cities with carrying the conventional mobile terminal, the conventional mobile terminal may display wrong current time of the target city since the origin city is changed.

### SUMMARY OF THE INVENTION

One aspect of the present invention provides a method for displaying precision current times of cities by storing information about time differences of cities based on a Greenwich Mean Time (GMT) in a time table of a mobile terminal, receiving current-time information including a current time and a time difference based on the GMT of corresponding city from a base station and using the time table and the current-time information.

Another aspect of the present invention provides a method for displaying precision current times of cities by storing information about time differences of cities based on the GMT and adaptation of a summer time system in a time table of a mobile terminal, receiving current-time information including a current time, a time difference based on the GMT and adaptation of a summer time system of corresponding city from a base station and using the time table and the current-time information.

Another aspect of the present invention provides a method for displaying a current time of a target city in a mobile terminal having a storing unit and a displaying unit, the method including the steps of: a) storing information about time differences between predetermined cities and a Greenwich Mean Time (GMT) and adaptation of a summer time system of the predetermined cities into a time table in the storing unit of the mobile terminal; b) receiving time information from a base station when the mobile terminal is initialized; c) receiving a request of displaying a current time of a target city from a user; d) computing the current time of the target city based on the time information from the base station and the time table stored in the storing unit; and e) displaying the computed current time of the target city on the displaying unit.

Still another aspect of the present invention provides a method for displaying a current time of a target city in a mobile terminal having a storing unit, a CPU and a displaying unit, the method including the steps of: a) storing information about time differences between predetermined cities and a Greenwich Mean Time (GMT) into a time table in the storing unit of the mobile terminal; b) receiving time information from a base station when the mobile terminal is initialized; c) receiving a request of displaying a current time of a target city; d) computing the current time of the target city based on the time information from the base station and the time table stored in the storing unit; and e) displaying the computed current time of the target city.

### BRIEF DESCRIPTION OF THE DRAWINGS

Various embodiments of the present invention will become better understood with regard to the following description of the preferred embodiments given in conjunction with the accompanying drawings, in which:

FIG. 1 shows a time table stored in a conventional mobile terminal for calculating a current time of a target city;

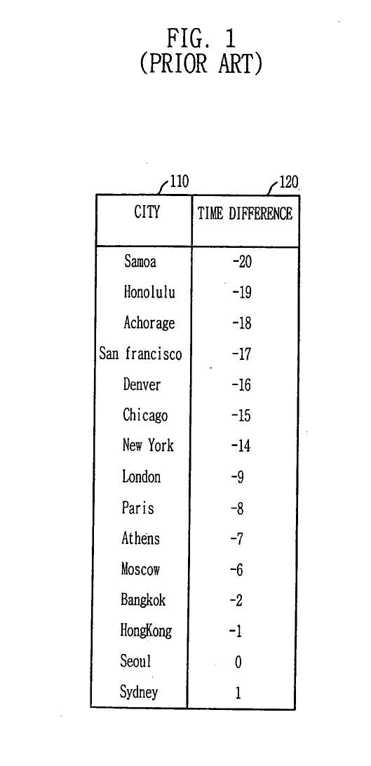

FIG. 2 is a diagram illustrating a mobile terminal displaying a current time of a target city by using information stored in a time table in accordance with a preferred embodiment of the present invention;

FIG. 3 is a diagram showing a time table in accordance with a preferred embodiment of the present invention;

FIG. 4 is a flowchart for explaining a method for displaying a current time of a target city in accordance with a preferred embodiment of the present invention;

FIG. 5 is a table showing examples of calculating current times of target cities in accordance with a preferred embodiment of the present invention; and

FIG. 6 is a flowchart for explaining a method for displaying a current time of a target city in accordance with another preferred embodiment of the present invention.

### DETAILED DESCRIPTION OF THE INVENTION

Hereinafter, a method for displaying precision current times of cities by using information stored in a time table and receiving time information from a base station in accordance with a preferred embodiment of the present invention will be described in detail with reference to the accompanying drawings.

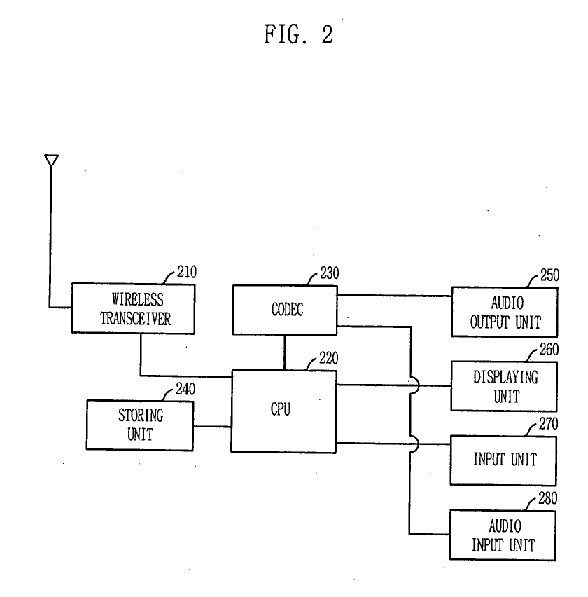

FIG. 2 is a diagram illustrating a mobile terminal displaying a current time of a target city by using time difference information stored in a time table and receiving time information from a base station in accordance with a preferred embodiment of the present invention.

As shown, the mobile terminal includes a wireless transceiver 210 for transceiving a signal through an antenna in a wireless communication link; a CPU 220 for calculating a current time of a target city based on information stored in a time table; a codec 230 for converting a receiving signal from the transceiver 210 into an audio signal and converting an audio input signal into a digital signal for transmitting the digital signal through the transceiver 210; a storing unit 240 for storing the time table; an audio output unit 250 for receiving the audio signal from the codec 230 and outputting the audio signal; a displaying unit 260 for displaying the current time of a target city; an input unit 270 for receiving a request signal to display a current time of a target city from a user; and an audio input unit 280 for receiving the audio input signal from the user.

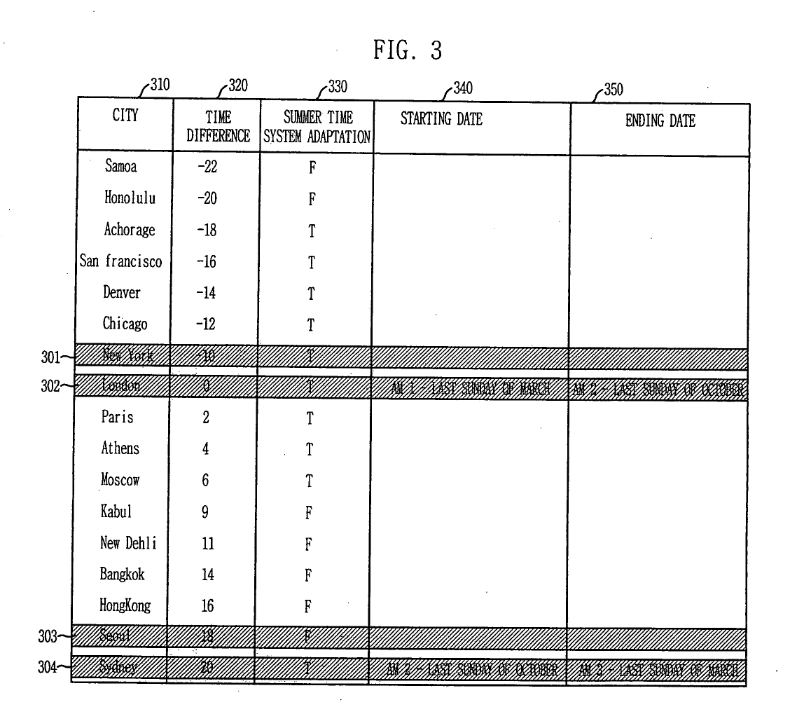

FIG. 3 is a diagram showing a time table in accordance with a preferred embodiment of the present invention.

As shown, the time table includes a city field 310, a time difference field 320, a summer time system adaptation field 330, a starting date field 340 and an ending date field 350.

The time difference field 320 includes time difference values representing time differences between standard times of predetermined cities and the GMT in a fundamental unit as 30 minutes. By using 30 minutes of the fundamental unit, the time table includes accurate time difference information for cities using standard times having multiple of 30 minutes different from the GMT.

The time difference values are positive integer numbers or negative integer numbers. If a time difference value is a positive integer number, a standard time of a corresponding city is faster than the GMT and if a time difference value is a negative integer number, a current time of the corresponding city is slower than the GMT.

For example, a time difference value of Denver is −14 and it represents that a standard time of Denver is 7 hours (14/2) slower than the GMT.

The summer time adaptation field 330 includes an adaptation value as “T” or “F.” “T” means true for representing that a corresponding city adapts a summer time system. “F” means false for representing that a corresponding city does not adapt the summer time system.

For example, New York has a value “T” in the summer time adaptation field 330. That is, New York adapts the summer time system.

The starting date field 340 includes a date starting of the summer time system.. If a corresponding city does not adapt the summer time system, the starting date field 340 is empty.

The ending data field 350 includes a date ending of the summer time system. If a corresponding city does not adapt the summer time system, the ending date field 350 is empty.

The time table of FIG. 3 is stored in the storing unit of the mobile terminal when the mobile terminal is manufactured.

When the mobile terminal is powered on, the mobile terminal receives a signal from a base station, wherein the signal includes information on a current time of the current city, a time difference based on the GMT (Ltm_off (Local_time_offset)) and adaptation of the summer time system. The mobile terminal sets it's time based on the current time of the current city where the mobile terminal is powered on. The current time of the current city is calculated according to the adaptation of the summer time system.

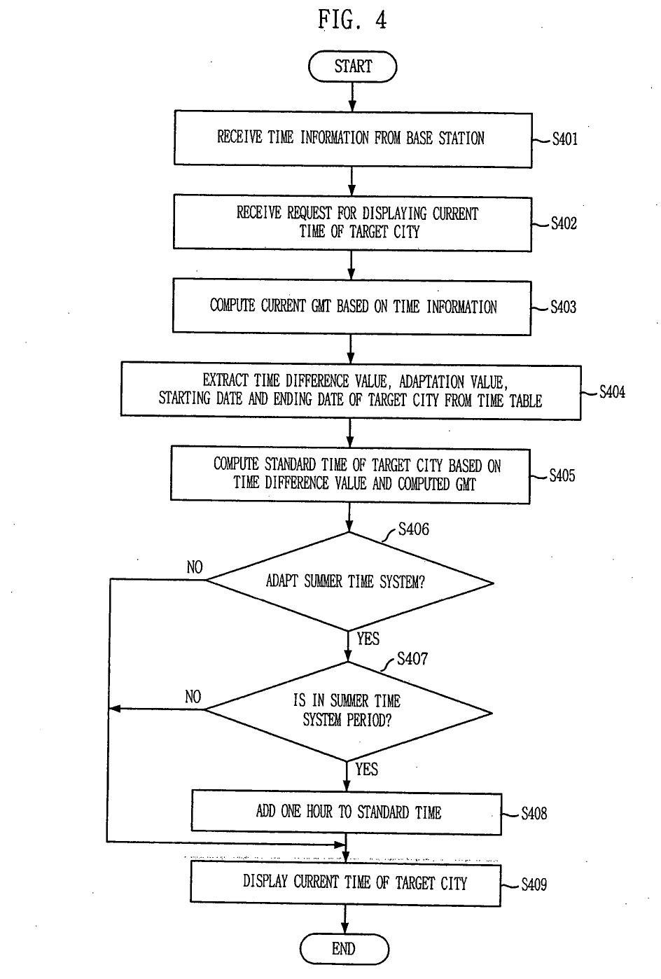

FIG. 4 is a flowchart for explaining a method for displaying a precision current time of a, target city in accordance with a preferred embodiment of the present invention.

It assumes that the mobile terminal stores the time table shown in FIG. 3 and the mobile terminal sets it's time based on the time information received from the base station, wherein the current time of a current city is a time of current location determined by considering the summer time system.

Also, the mobile terminal computes a current GMT based on information including the time difference (Ltm_off (Local_time_offset)), the current time of the current city and the adaptation of the summer time from the base station.

In other words, the mobile terminal can calculate the current GMT based on the time difference (Ltm_off (Local_time_offset)), the adaptation of the summer time system (Daylt(Daylight)) and the current time of the current location where the mobile terminal is located when a clock in the mobile terminal is operated according to the current time of the current city transmitted from a base station.

The mobile terminal may receive the current GMT from the base station. If the mobile terminal directly receives the current GMT from the base station, the mobile terminal may cancel operations of computing the current GMT based on the time information from the base station.

At step S401, a mobile terminal receives time information from a base station, wherein the time information includes a current time of a current city, a time difference and an adaptation of a summer time system. The received time difference is a time difference between a current time of a current location where the mobile terminal is located and the GMT.

At step S402, a CPU of the mobile terminal receives a request signal for displaying a current time of a target city through an input unit from a user of the mobile terminal.

At step S403, the current GMT is computed based on the time information.

After computing the current GMT, the CPU extracts target city's information including a time difference value from a time difference field, an adaptation value from a summer time adaptation field and a starting date and an ending date from the starting date field and the ending date field in the time table at step S404.

The CPU computes a standard time of the target city based on a time difference value of the target city from the time table and the computed GMT at step 405.

After computing the standard time, it determines whether the target city adopts a summer time system or not by using the adaptation value at S406.

If the target city adapts the summer time system, it determines whether a current date of the target city is in a summer time period by using the starting date and the ending date at step S407. The summer time period is obtained based on the starting date and the ending date of the summer time system by extracting information in the starting date field and the ending date field in the time table. Otherwise, the standard time is displayed at a displaying unit of the'mobile terminal as a current time of the target city at step S409.

If the current date of the target city is in the summer time period, one hour is added to the standard time of the target city at step S408 and the one hour added standard time is displayed as the current time of the target city at step S409. If the current date of the target city is not in the summer time period at step S406, the standard time is displayed without adding one hour as the current time at step S409.

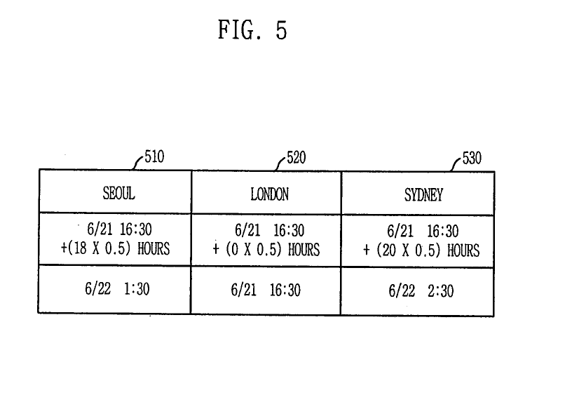

FIG. 5 is a table showing examples of calculating precision current times of target cities in accordance with a preferred embodiment of the present invention.

If a user turns on a mobile terminal in a city of New York on 12:30 of 21^{st} of June, the mobile terminal receives time information from a base station. Based on the time information, a current time of a current city and a current date of the mobile terminal initially set to 12:30 of 21^{st} of June. The mobile terminal calculates a standard time by using the time information, an adaptation value from a summer time adaptation field in the time table and a period of the summer time system from a starting data field and ending date field. That is, the standard time of the New York is 11:30 of 21^{st} of June by subtracting one hour from the current time of the New York since the current date of the New York is in the period of the summer time and the adaptation value is “T.” After calculating the standard time of the New York, the current GMT is calculated based on the standard time of New York and a time difference value from the time information. That is, the GMT is calculated as 16:30 of 21^{st} June by adding a time difference value of the New York to the standard time (5 hours+11:30 of 21^{st} June)

The mobile terminal can calculate and display current times of target cities based on the calculated GMT as mentioned above.

Referring to a column 510 of the table in FIG. 5, when the user requests to display a current time of Seoul, a CPU of the mobile terminal extracts time information including a time difference value from a time difference field, an adaptation value from a summer time adaptation field and a period of the summer time system from a starting date field and an ending data field in a time table. Based on the time information, a standard time of Seoul is computed by adding the time difference to GMT. According to the time table shown in FIG. 3, the time difference value of Seoul is 18 and the adaptation value of Seoul is “F.” Therefore, 9 hours are added to GMT which is 16:30 on 21^{st} June. 9 hours are computed by 18/2 since a fundamental unit of time difference in FIG. 3 is 30 minutes. Therefore, the standard time for Seoul is 1:30 on 22^{nd} June.

Furthermore, the city of Seoul does not adapt the summer time system since a value of the summer time adaptation field is “F.” Finally, the CPU displays 1:30 on 22^{nd} June as the current time of Seoul.

Referring to a column 520 of the table in FIG. 5, when the user requests to display a current time of London, the CPU of the mobile terminal extracts time information about the time difference value, the adaptation value and a period of the summer time system from the time table. Based on the time information, a standard time of London is computed by adding the time difference to GMT. According to the time table shown in FIG. 3, a value of the time difference field of London is 0 and a value of the summer time adaptation field is “T.” Therefore, 0 hours are added to GMT which is 16:30 on 21^{st} June. Furthermore, the CPU determines that London adapts the summer time system since the adaptation value is “T.” Also, the CPU determines that a current date of London is included in a period of the summer time system based on information from the starting date field and the ending date field in the time table. Therefore, the CPU of the mobile terminal adds one hour to the standard time of London. Finally, the CPU displays 17:30 on 21^{st} June as the current time of London.

Referring to a column 530 of the table in FIG. 5, when the user requests to display a current time of Sydney, the CPU of the mobile terminal extracts time information about the time difference value, the adaptation value and a period of the summer time system from the time table. Based on the time information, a standard time of Sydney is computed by adding the time difference to GMT. According to the time table shown in FIG. 3, the time difference value of Sydney is 20 and the adaptation value is “T.” Therefore, 10 hours are added to GMT which is 16:30 on 21^{st} June for computing the standard time of Sydney. Furthermore, the CPU determines that Sydney adapts the summer time system since the value of the summer time adaptation is “T.” Also, the CPU determines that a current date of Sydney is not included in a period of the summer time system. Therefore, the CPU of the mobile terminal does not add one hour to the standard time of Sydney. Finally, the CPU displays 2:30 on 22^{nd} June as the current time of Sydney

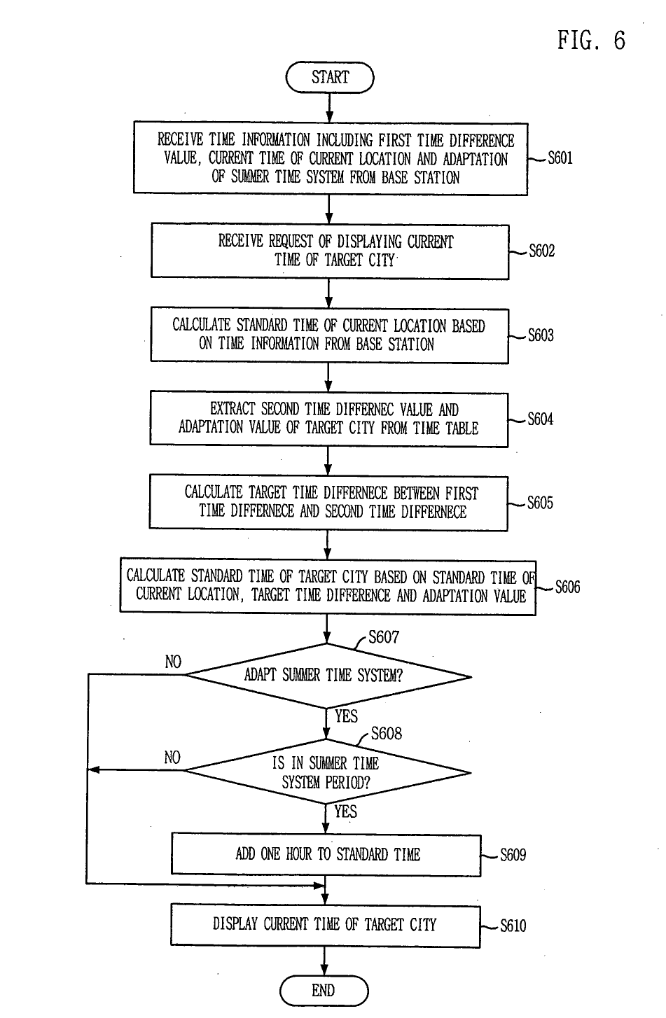

FIG. 6 is a flowchart for explaining a method for displaying a precision current time of a target city in accordance with another preferred embodiment of the present invention.

As shown, a mobile terminal receives time information including a current time of a current location, a first time difference value of a current location of the mobile terminal and an adaptation of summer time system of the current location from a base station at step S601.

A CPU of the mobile terminal receives a request of displaying a current time of a target city through an input device at step S602.

The CPU of the mobile terminal calculates a standard time of the current location by using the current time of the current location and the adaptation of summer time system from the time information at step S603. The standard time is a time without adapting the summer time system. Therefore, the standard time is calculated by subtracting one hour from the current time of the current location if the current date of the current location is in a period of the summer time system.

After calculating the standard time of the current location, the CPU of the mobile terminal extracts a second time difference from a time difference field of the target city and an adaptation value from a summer time adaptation filed in a time table stored in the mobile terminal at step S604.

The CPU of the mobile terminal calculates a target time difference between the first time difference of the current location and the second time difference from the time table at step S605.

The CPU of the mobile terminal calculates a standard time of the target city based on the standard time of the current location, the target time difference and the adaptation value of the target city from the time table at step S606.

After calculating the standard time of the target city, it determines whether the target city adapts the summer time system or not based on an adaptation value from a summer time adaptation field in the time table at step S607.

If the target city does not adapt the summer time system, the standard time of the target city is displayed as a current time of the target city at step S610.

If the target city adapts the summer time system, it determines whether a current date of the target city is in the period of the summer time system at step S608.

If the current date is not in the period of the summer time system then the standard time of the target city is displayed as a current time of the target city at step S610.

If the current date is in the period of the summer time system then one hour is added to the standard time of the target city at step S609.

After adding one hour to the standard time, the calculated time is displayed as the current time of the target city at step S610.

Hereinafter, the method for displaying a precision current time of a target city in accordance with another preferred embodiment of the present invention is explained in detail.

For example, it assumes that a mobile terminal is turned on at a city of New York. At first, the mobile terminal receives time information including a current time of current location, a time difference (ltm_off) and adaptation of a summer time system (daylt) from a base station. Based on the time information, the mobile terminal realizes that the current time of current location is 11:30 of 21^{st} June and a time difference vale is −10(−5 hours) which means that a standard time of the current location is 5 hours slower than the GMT. The mobile terminal also determines that the current location adapts the summer time system and the current date of the current location is in a period of the summer time system. And mobile terminal recognizes that the current location of the mobile terminal is in the city of New York by searching the time difference value(−10, −5 hours) from the time table stored in the mobile terminal. After determining the current location, current time of New York and adaptation of the summer time system, a standard time of the current location is calculated based on the time information from the base station. That is, the New York adapts the summer time system and the current date is in the period of the summer time system, the standard time of the New York is calculated as 10:30 of 21^{st} June by subtracting one hour from the current time of the New York.

Under the above condition, if a user of the mobile terminal wants to know a current time of London, the mobile terminal searches a time difference value, an adaptation value of London from the time table stored in the mobile terminal. Also, a period of the summer time system of London is obtained based on a starting date field and an ending date field of London in the time table. The time difference value of London is 0 and the time difference value of the current location is −10 which means 5 hours slower than the GMT. Therefore, the difference between the time difference value of London and the time difference value of the current location is 5((0−(−10))/2). That is, London is 5 hours faster than the current location, New York. Therefore, a standard time of the London is 15:30 of 21^{st} June. After calculating the standard time of the target city London, a current time of London is calculated by considering an adaptation of a summer time system. Since the adaptation value of the London is “T” and the current date of London is in the period of the summer time system, the current time of London is 16:30 of 21^{st} June by adding one hour to the standard time of London.

For another example, if the user wants to know a current time of Seoul, the mobile terminal searches a time difference value of Seoul, an adaptation value of Seoul from the time table stored in the mobile terminal. Also, a period of the summer time system of Seoul is obtained based on a starting date field and an ending date field of Seoul in the time table. The time difference value of Seoul is +18 which means 9 hours faster than the GMT and the time difference value of the current location, New York is −10 which means 5 hours slower than the GMT. Therefore, the difference between the time difference value of Seoul and the time difference value of the current location is 14((18−(−10))/2). That is, Seoul is 14 hours faster than the current location, New York. Therefore, a standard time of the Seoul is 0:30 of 22^{nd} June. After calculating the standard time of the target city Seoul, a current time of Seoul is calculated by considering an adaptation of a summer time system. Since an adaptation value of the Seoul is “F,” the standard time of the Seoul becomes the current time of Seoul as 0:30 of 22^{nd} June.

For still another example, if a user of the mobile terminal wants to know a current time of Sydney, the mobile terminal searches a time difference value, an adaptation value of Sydney from the time table stored in the mobile terminal. Also, a period of the summer time system of Sydney is obtained based on a starting date field and an ending date field of Sydney in the time table. The time difference value of Sydney is +20 which means 10 hours faster than the GMT and the time difference value of the current location, New York is −10 which means 5 hours slower than the GMT. Therefore, the difference between the time difference value of Sydney and the time difference value of the current location is 15((20−(−10))/2). That is, Sydney is 15 hours faster than the current location. Therefore, a standard time of the Sydney is 1:30 of 22^{nd} June. After calculating the standard time of the target city Sydney, a current time is calculated by considering an adaptation of a summer time system. Since the adaptation value of the Sydney is “T” and the current date of Sydney is not in the period of the summer time system, the standard time becomes the current time of Sydney as 1:30 of 22^{nd} June.

As mentioned above, the present invention can display a precision current time of a target city based on information stored in the time table in a mobile terminal.

Also, the present invention can display a precision current time of a target city without modifying a time table stored in a mobile terminal when a user uses the mobile terminal in other cities since the time table includes information of time difference based on the GMT.

Furthermore, the present invention can display a precision current time of target city by determining whether the target city adapts a summer time system.

Moreover, the present invention can display a precision current time of target city by using 30 minutes as fundamental unit for a time difference based on GMT.

The present application contains subject matter related to Korean patent application Nos. KR 2003-0048249 and KR 2004-0047310, filed in the Korean patent office on Jul. 15, 2003 and Jun. 23, 2004, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

1. A method for displaying a current time of a target city in a mobile terminal having a storing unit and a displaying unit, the method comprising:
a) storing information about time differences between predetermined cities and a Greenwich Mean Time (GMT) and adaptation of a summer time system of the predetermined cities into a time table in the storing unit of the mobile terminal;
b) receiving time information from a base station when the mobile terminal is initialized;
c) receiving a request of displaying a current time of a target city from a user;
d) computing the current time of the target city based on the time information from the base station and the time table stored in the storing unit; and
e) displaying the computed current time of the target city on the displaying unit.

2. The method of claim 1, wherein the time information includes a current time of a current location where the mobile terminal is located, a first time difference value representing a time difference between the current location and the GMT and a first adaptation value representing an adaptation of a summer time system.

3. The method of claim 1, wherein the time table includes second time difference values representing time differences between predetermined cities and the GMT, second adaptation values representing adaptation of a summer time system of the predetermined cities, starting dates and ending dates representing dates start and end the summer time of the predetermined cities.

4. The method of claim 1, wherein the computing includes:
d-1) computing a current GMT based on the current time of the current location and a first time difference from the time information;
d-2) extracting a second time difference of the target city and a second adaptation value of the target city from the time table; and
d-3) computing the current time of the target city by using the computed current GMT, the extracted second time difference and the extracted adaptation value.

5. The method of claim 4, wherein the computing (d-3) includes:
d-3-I) computing a standard time of the target city by adding the current GMT and the extracted second time difference;
d-3-II) determining whether the target city adapts the summer time system based on the extracted second adaptation value;
d-3-III) computing the current time of the target city by adding one hour to the standard time, if the target city adapts the summer time system; and
d-3-IV) determining the standard time as the current time of the target city, if the target city does not adapt the summer time system.

6. The method of claim 1, wherein the computing includes:
d-a) computing a first standard time of a current location by using the current time of the current location, a first time difference value and a first adaptation value from the time information;
d-b) extracting a second time difference value of the target city and a second adaptation value of the target city from the time table;
d-c) computing a target time difference between the first time difference and the second time difference; and
d-d) computing a current time of the target city by using the first standard time of the current location, the target time difference and the second adaptation value of the target city.

7. The method of claim 6, wherein the computing (d-a) includes:
d-a-1) determining whether the current location adapts a summer time system based on the first adaptation value included in the time information from the base station;
d-a-2) calculating the standard time of the current location by subtracting one hour from the current time included in the time information in a case that the current location adapts the summer time system; and
d-a-3) selecting the current time as the standard time of the current location in a case that the current location does not adapts the summer time system.

8. The method of claim 6, wherein the computing (d-d) includes:
d-d-1) computing a second standard time of the target city by adding the first standard time to the target time difference;
d-d-2) determining whether the target city adapts the summer time system based on the second adaptation value from the time table;
d-d-3) computing the current time of the target city by adding one hour to the second standard time if the target city adapts the summer time system; and
d-d-4) determining the second standard time as the current time of the target city if the target city does not adapt the summer time system.

9. The method of claim 1, wherein the time table stores the time differences between the current location and GMT on 30 minutes basis.

10. A method for displaying a current time of a target city in a mobile terminal having a storing unit, a CPU and a displaying unit, the method comprising:
a) storing information about time differences between predetermined cities and a Greenwich Mean Time (GMT) into a time table in the storing unit of the mobile terminal;
b) receiving time information from a base station when the mobile terminal is initialized;
c) receiving a request of displaying a current time of a target city;
d) computing the current time of the target city based on the time information from the base station and the time table stored in the storing unit; and
e) displaying the computed current time of a target city.

11. The method of claim 10, wherein the time information includes a current time of a current location where the mobile terminal is located and a first time difference value representing a time difference between the current location and the GMT.

12. The method of claim 11, wherein the computing includes:
d-1) extracting a second time difference value of the target city from the time table;
d-2) calculating a target time difference by determining difference between the first time difference value and the second time difference value; and
d-3) computing the current time of the target city by adding the target time difference and the current time of the current location from the time information.

13. A mobile terminal for displaying a precision current time of a target city, the mobile terminal comprising:
means for calculating a current time of a target city based on time information from a base station and information stored in a time table; and
means for storing the time table, wherein the time table includes time differences between predetermined cities and a Greenwich Mean Time (GMT), adaptation values, and summer time period of the predetermined cities.

14. A method of providing a current time of a target city in a mobile terminal, the method comprising:
storing information about time differences between predetermined cities and a base time on the mobile terminal;
receiving time information from a base station when the mobile terminal is initialized;
computing the current time of the target city based on the time information received from the base station and the stored information; and
providing, to a user, the computed current time of a target city.

15. An apparatus for providing a current time of a target city in a mobile terminal, the apparatus comprising:
means for storing information about time differences between predetermined cities and a base time on the mobile terminal;
means for receiving time information from a base station when the mobile terminal is initialized;
means for computing the current time of the target city based on the time information received from the base station and the stored information; and
means for providing, to a user, the computed current time of a target city.
